(19) United States
(12) Patent Application Publication
(10) Pub. No.: US 2012/0311919 A1
(43) Pub. Date: Dec. 13, 2012

(54) Flying Pest Trap

(76) Inventor: Walter T. Hardigree, Hartwell, GA (US)

(21) Appl. No.: 13/158,285

(22) Filed: Jun. 10, 2011

(51) Int. Cl. A01M 1/10

(52) U.S. Cl. 43/107

(57) ABSTRACT

Disclosed embodiments are directed towards providing a flying pest trap. Exemplary embodiments may include a bowl having an “island” feature positioned such that a “moat” is created within the bowl. In some embodiments, a bait holding mechanism may extend perpendicularly upward from the island feature. In other embodiments, bait holding mechanisms may be anchored on the island feature and operable to extend over the moat. In other embodiments, bait holding mechanisms may be anchored at intervals along the exterior wall and operable to extend toward the center of the bowl. In operation, embodiments may be filled with a liquid such as soapy water. A bait substance for attracting certain insects may be placed on one or more of the bait spikes. When insects, such as wasps, are attracted to the bait, the erratic flight of the insects may cause them to come into contact with, and drown in, the liquid.

### CROSS-REFERENCE TO RELATED APPLICATIONS

This application is related to the United States design application filed concurrently herewith under 37 CFR 1.53(d), having a title of FLYING PEST TRAP, identified by attorney docket number 08028.1020 and filed under customer number 35856, the entire contents of which are hereby incorporated by reference.

### BACKGROUND

The general term “wasp” incorporates several common varieties such as hornets, yellow jackets and paper wasps. Despite that wasps often provide a benefit to humans by preying on garden pests and other insects, the potential misfortune of being on the receiving end of a venomous sting often makes a wasp an unwelcomed guest. For example, wasps nesting too close to a residential or play area pose a stinging hazard to small children and other family members in the vicinity.

Because wasps and other flying insects are considered nuisances, various devices to trap and kill wasps and other stinging or biting insects have been devised over the years. Notably, most of these traps use limited or barbed accesses that allow a wasp to enter a container while preventing the wasp from exiting the same. To lure a wasp through the one-way access point, many of these traps are filled with bait that attracts wasps. Once a wasp enters the trap, a quantity of liquid inside the container drowns the wasp when it can no longer stay aloft.

Traps such as those briefly described above may be either homemade from jugs or bottles or mass produced using various glass or plastic containers. The homemade traps, in particular, can be cumbersome and fragile, not to mention unsightly and ill-suited for placement around a residence. The manufactured traps, though often more elegant than the homemade traps, from an aesthetic standpoint anyway, can be bulky and unwieldy to ship and store.

Therefore, what is needed in the art is a flying pest trap that is small and unobtrusive for use around a residence or play area. Further, what is needed is a flying pest trap that can be conveniently stored and shipped in sets. Even further, what is needed in the art is a flying pest trap that is simple to bait and fill.

### BRIEF SUMMARY

Disclosed embodiments, as well as features and aspects thereof, are directed towards providing a flying pest trap. Exemplary embodiments of a flying pest trap may include a bowl having an “island” feature positioned substantially in its center such that an annular cavity or “moat” suitable for containing a liquid is defined within the bowl. In some embodiments, a bait holding mechanism, such as a spike, may extend upward from the island feature. In other embodiments, one or more bait holding mechanisms may be anchored on the island feature and operable to extend over the moat. Similarly, in other embodiments, one or more bait holding mechanisms may be anchored at intervals along the exterior wall of the bowl such that the bait holding mechanisms are operable to extend away from the wall and out over the moat.

Exemplary embodiments of a flying pest trap may include an outer wall having a diameter along its top surface that exceeds the diameter along its bottom surface. Similarly, in embodiments that feature an island, the top of the island feature may have a diameter that is less than the diameter of the island at the base of the bowl. That is, in some embodiments, the walls of the various features may be sloped. As one of ordinary skill in the art will recognize, embodiments of a flying pest trap that feature sloped walls may be configured to “nest” one inside the other such that a set of multiple flying pest traps may be compactly stacked and stored. Notably, for stackable embodiments which feature a bait spike extending substantially vertical from an island feature, the bait spike of one flying pest trap may be accommodated by an interior cavity defined by the underside of an island feature of another flying pest trap. Similarly, for stackable embodiments that include bait holding mechanisms that are operable to extend out over the moat cavity, the bait holding mechanisms may be translatable from a first, in-use position to a second, storage position that is out of the way when a second flying pest trap is nested. Moreover, for such embodiments having bait holding mechanisms that may be translated between a first and a second position, one of ordinary skill in the art will recognize that a spring mechanism may be included that causes the bait holding mechanisms to automatically “fail” to a position over the moat when nested flying pest traps are separated.

In operation, the moat feature of a given flying pest trap embodiment may be filled with a liquid such as, but not limited to, soapy water. A bait substance for attracting certain insects may be placed on one or more of the bait spikes. When insects, such as wasps, are attracted to the bait, the erratic flight of the insects may cause the insects to come into contact with the liquid held in the moat. Advantageously, upon contact, the liquid will wet the wings and body of the wasp or other flying insect, thus preventing further flight. Moreover, when soapy water or other liquids are used in the moat, the liquid may coat the body of the wasp, thereby plugging breathing holes and essentially drowning the wasp.

### BRIEF DESCRIPTION OF THE SEVERAL VIEWS OF THE DRAWING

FIG. 1 is a perspective view of a flying pest trap according to an exemplary embodiment of the invention.

FIG. 2 is a cross-sectional, elevation view of the exemplary flying pest trap of FIG. 1.

FIG. 3 is a cross-sectional, elevation view of a stacked set of the exemplary flying pest traps of FIG. 1.

FIG. 4 is a cross-sectional, elevation view of a flying pest trap according to an exemplary embodiment of the invention.

FIG. 5 is a cross-sectional, elevation view of a stacked set of the exemplary flying pest traps of FIG. 4.

FIG. 6 is a cutaway, perspective view of a flying pest trap according to an exemplary embodiment of the invention.

FIG. 7 is a detail view of an exemplary bait holding mechanism included in the exemplary flying pest trap of FIG. 6.

FIG. 8 is a cross-sectional, elevation view of a stacked set of the exemplary flying pest traps of FIG. 6.

### DETAILED DESCRIPTION

The presently disclosed embodiments, as well as features and aspects thereof, are directed towards providing a flying pest trap for attracting and eliminating wasps. As will become apparent from a review of the drawings and the following description, exemplary embodiments of a flying pest trap may be leveraged around a residence or play area for attracting and killing flying insects such as wasps. Further, certain exemplary embodiments of a flying pest trap may be configured such that multiple traps can be compactly stacked and stored.

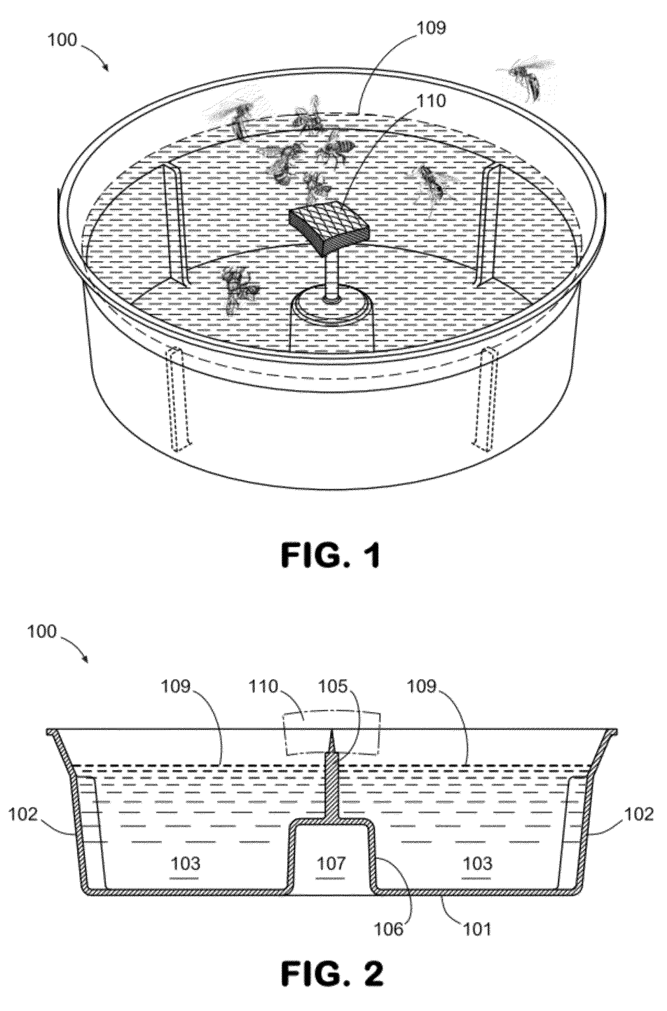

FIG. 1 is a perspective view of a flying pest trap 100 according to an exemplary embodiment of the invention. The exemplary embodiment of a flying pest trap 100 includes a bowl having an “island” feature 106 positioned substantially in its center such that an annular cavity or “moat” 103 suitable for containing a liquid is defined within the bowl. A bait holding mechanism 105 in the form of a spike extends upward from the island feature 106. Notably, although the particular embodiments depicted in the figures include bait holding mechanisms in the general form of “spikes,” one of ordinary skill in the art will recognize that other bait holding mechanisms including, but not limited to, hooks, platforms, nets, pincers, clips, etc. are within the scope of the disclosure.

In operation, the moat feature 103 of the flying pest trap embodiment 100 may be filled with a liquid 109 such as, but not limited to, soapy water. A bait substance 110 for attracting certain insects, such as wasps, may be placed on the bait spike 105. When a wasp approaches the bait 110, its naturally erratic flight pattern may cause it to come into contact with the liquid 109 held in the moat 103. Advantageously, upon contact, the liquid 109 will wet the wings and body of the wasp, thus preventing further flight and causing the wasp to drown.

FIG. 2 is a cross-sectional, elevation view of the exemplary flying pest trap 100 of FIG. 1. The flying pest trap can be more specifically described as having a base 101 and a circumferential wall 102 that generally define a bowl structure. At substantially the center of the bowl structure, a raised spike 105 for holding bait 110 is depicted atop the inner island 106. The base 101, circumferential wall 102, and the inner island 106 operate in conjunction to define a cavity or “moat” 103 useful for holding a liquid 109. The island feature 106 also defines an interior cavity 107 that is open from beneath base 101.

In the exemplary embodiment 100 of a flying pest trap, the circumferential wall 102 that defines the outer edge of the liquid holding cavity 103 is circular in shape. It is envisioned, however, that in other embodiments the liquid holding cavity 103 may take the form of other shapes such as square, oval, triangular or any other shape which creates a liquid holding cavity 103 capable of retaining a liquid. Moreover, it is also envisioned that some embodiments of a flying pest trap may include liquid holding cavities that are not annular in shape like the cavity 103 of the FIG. 1 embodiment. Further, it is also envisioned that the volume of the liquid holding cavity 103 in alternate embodiments of the invention may vary based upon application or ornamental preferences of the user. As such, one of ordinary skill in the art will recognize that the particular embodiments illustrated in the figures are being offered for exemplary purposes only and that the overall shape, liquid holding cavity size or volume are not limiting aspects of a flying insect trap.

Returning to the exemplary embodiment 100 shown in FIGS. 1-2, a bait holding mechanism 105 in the form of a spike is positioned substantially in the center of the liquid holding cavity 103, atop the island feature 106 such that a wasp-attracting bait 110 may be secured thereon and positioned near the surface of liquid 109 held in the cavity 103. Consequently, the erratic flight patterns of wasps will cause them to contact the liquid 109 when they are trying to hover near the bait 110. As explained above, a wasp that inadvertently comes into contact with liquid 109 held in the cavity 103 may become unable to fly and quickly drown.

The spike 105 in the exemplary embodiment 100 is a cylindrical protrusion with a sharpened point. The spike 105 may be integrally constructed of the same plastic or other material of which the balance of the flying pest trap 100 is constructed, although it is envisioned that components within any given embodiment of a flying pest trap may vary in materials of construction. Moreover, in other embodiments, it is envisioned that the bait holding mechanism may take the form of a shape other than a spike such as, but not limited to, a clip, hook, barb, or hoop. Additionally, it will be understood by one of ordinary skill in the art that a bait holding mechanism of a given embodiment may be integral to another feature of the embodiment or, alternatively, may be removably connected to another feature by way of screw fittings, fasteners, magnets, etc.

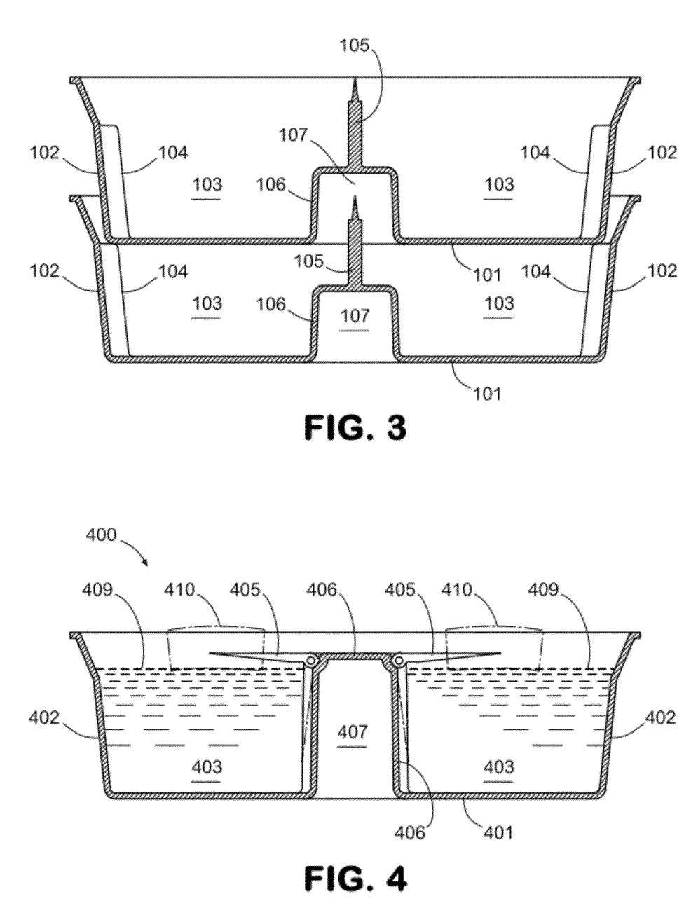

Turning now to FIG. 3, a cross-sectional, elevation view of a stacked set of the exemplary flying pest traps 100 of FIGS. 1-2 is depicted. The exemplary embodiment 100 includes an outer circumferential wall 102 in which the diameter of the top of the wall is slightly larger than the diameter of the bottom. As such, the wall 102 is sloped at an outward angle such that a second flying pest trap 100 may be received and nested into the first.

Notably, multiple flying pest traps 100 will stack in a manner that the spikes 105 are protected from being broken or bent. Because the island 106 defines an interior cavity 107, when stacked the spikes 105 are accommodated by the series of interior cavities 107, and thus be protected from damage. Additionally, the exemplary flying pest trap 100 features a plurality of support ribs 104 that may be positioned perpendicularly along the inside of circumferential wall 102 such that the base 101 of a second flying pest trap 100 may be supported. One of ordinary skill in the art will recognize that support ribs 104 are not required in all embodiments of a flying pest trap, as it is envisioned that some embodiments may nest in a more compact manner.

FIG. 4 is a cross-sectional, elevation view of an exemplary embodiment 400 of a flying pest trap having hinged bait holding mechanisms 405. Similar to the embodiment 100, the exemplary embodiment 400 includes a bowl having an “island” feature 406 positioned substantially in its center such that an annular cavity or “moat” 403 suitable for containing a liquid 409 is defined within the bowl. A bait holding mechanism 405 in the form of a spike extends radially outward from the island feature 406. The bait holding mechanisms 405 are translatable from a first, in-use position suitable for holding a bait 410 to a second, storage position against the vertical wall of island 406. Notably, although the bait holding mechanisms 405 are depicted as including indent aspects for holding in a position, it is envisioned that other embodiments may further include “spring loaded” aspects such that a “normally extended” spring anchored on the island 406 would operate to place a bait holding mechanism 405 in a position directly over liquid holding cavity 403. Advantageously, by placing a bait holding mechanism directly over liquid holding cavity 403, one of ordinary skill in the art will recognize that flying insects may be more likely to come into contact with liquid 409 held in moat 403.

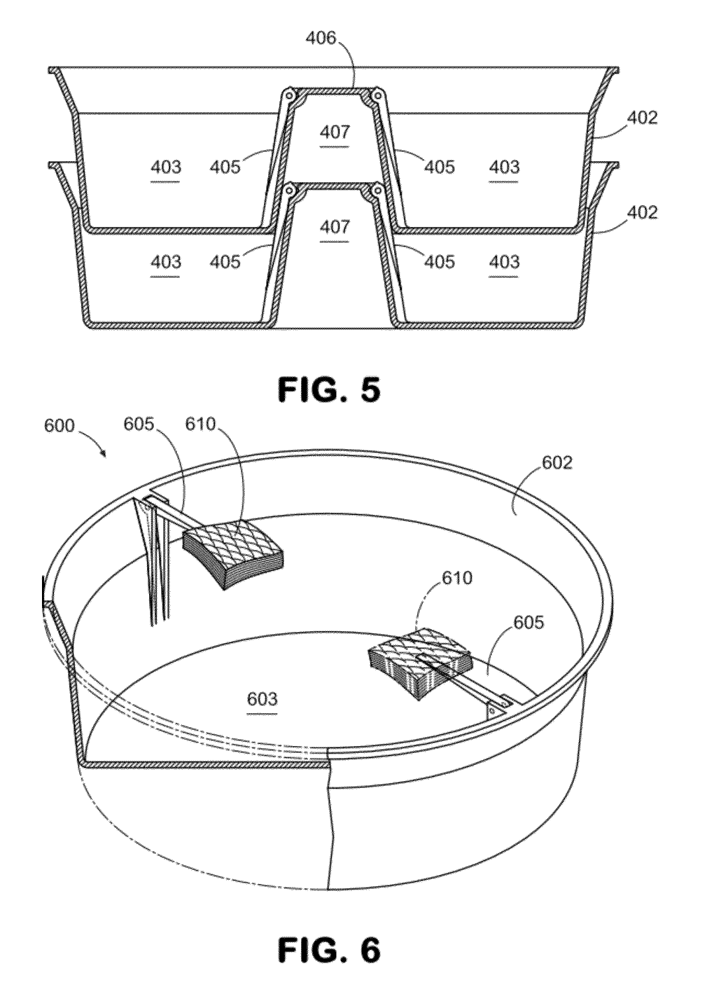

FIG. 5 is a cross-sectional, elevation view of a stacked set of the exemplary flying pest traps 400 of FIG. 4. Similar to the stacked set of flying pest traps 100 described relative to FIG. 3, the multiple traps 400 may be nested one in another. Notably, because the bait holding mechanisms 405 are translatable from an in-use position to a storage position, the bait holding mechanisms 405 may be hinged to a position substantially parallel to the outer wall of island feature 406 when a second trap 400 is nested on top of a first.

FIG. 6 is a cutaway, perspective view of a flying pest trap according to an exemplary embodiment 600 of the invention. Unlike exemplary embodiments 100 and 400, the exemplary embodiment 600 includes a bowl without an “island” feature. As such, the liquid holding cavity 603 is not in the shape of a moat. Bait holding mechanisms 605 in the form of spikes extend radially inward from the outer wall 602 that generally defines liquid holding cavity 603. The bait holding mechanisms 605 are translatable from a first, in-use position suitable for holding a bait 610 to a second, storage position against the interior surface of vertical outer wall 602. Notably, although the bait holding mechanisms 605 are depicted as including indent aspects for holding in a position, it is envisioned that other embodiments may further include “spring loaded” aspects such that a “normally extended” spring anchored on the outer wall 602 would operate to place a bait holding mechanism 605 in a position directly over liquid holding cavity 603. Advantageously, by placing a bait holding mechanism directly over liquid holding cavity 603, one of ordinary skill in the art will recognize that flying insects may be more likely to come into contact with liquid held in liquid holding cavity 603.

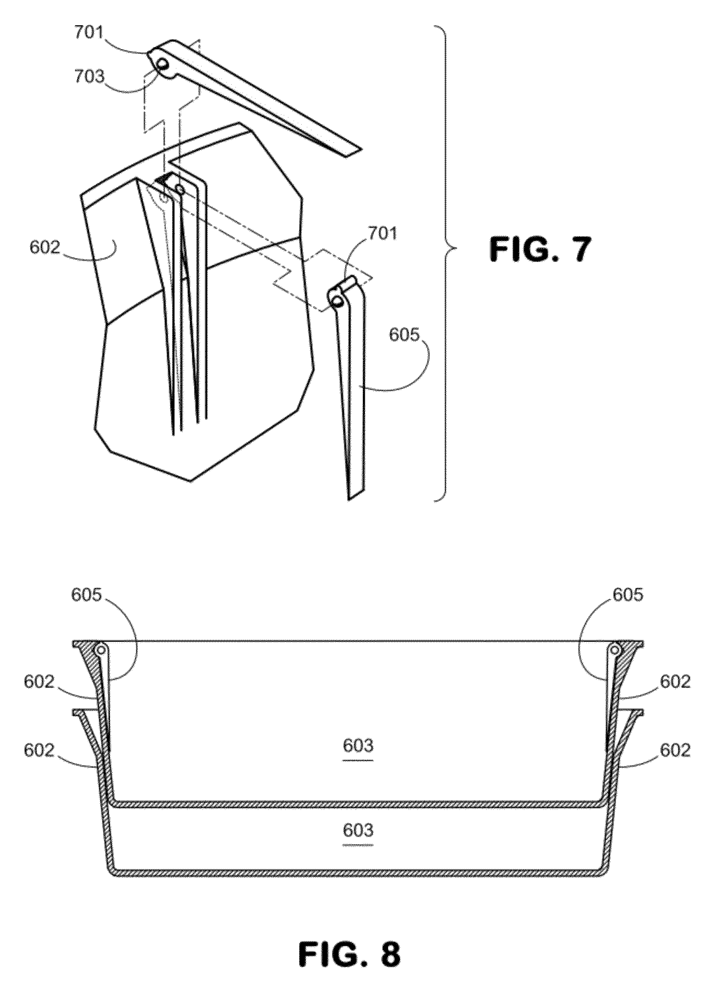

FIG. 7 is a detail view of exemplary bait holding mechanism 605 included in the exemplary flying pest trap of FIG. 6. As can be seen in the detailed view, bait holding mechanism 605 includes a hinge aspect 703 and a protrusion 701. As one of ordinary skill in the art will understand, hinge aspect 703 enables the bait holding mechanism 605 to be translated from an in-use position that extends away from wall 602 to a storage position that is parallel to wall 602. When bait holding mechanism 605 is positioned in the in-use position, protrusion 701 “snaps” into a complimentary receiving depression, thus securing the bait holding mechanism 605 in position. Notably, the exemplary bait holding feature 605 is offered for illustrative purposes only and is not necessarily included in all embodiments of a flying insect trap having translatable bait holding mechanisms. One of ordinary skill in the art will recognize other means for securing a translatable bait holding feature in a position and, as such, the particular features and aspects associated with a bait holding mechanism will not limit the scope of a flying insect trap that falls within the bounds of the present disclosure.

FIG. 8 is a cross-sectional, elevation view of a stacked set of the exemplary flying pest traps 600 of FIG. 6. Similar to the stacked set of flying pest traps 400 described relative to FIG. 5, the multiple traps 600 may be nested one in another. Notably, because the bait holding mechanisms 605 are translatable, the bait holding mechanisms 605 may be hinged to a position substantially parallel to the outer wall 602 when a second trap 600 is nested on top of a first.

Regarding the liquid that may be used in various embodiments of a flying pest trap, the liquid may be novel in and of itself. Even so, the particular liquid used in a given embodiment will not be a limiting factor for a flying pest trap that falls within the scope of the present disclosure. In some embodiments, water infused with dish soap or another surfactant may be leveraged to quickly and efficiently stop a wasp from flying and also coat a wasp's breathing holes to effectively drown it. In other embodiments, it is envisioned that the liquid may be any other liquid shown as effective to accomplish these tasks. Typically, the baits that are used in the art to attract wasps are various meat products and fruits. It is also envisioned that in any commercial insect bait may be employed for this purpose.

The present flying pest trap has been described using detailed descriptions of embodiments thereof that are provided by way of example and are not intended to limit the scope of the system. The described embodiments comprise different features, not all of which are required in all embodiments of a flying pest trap. Some embodiments of the invention utilize only some of the features or possible combinations of the features. Variations of the embodiments of the device that are described and embodiments of the invention comprising different combinations of features noted in the described embodiments will occur to persons of ordinary skill in the art.

It will be appreciated by persons of ordinary skill in the art that a flying pest trap is not limited by what has been particularly shown and described herein above. Rather, the scope of a flying pest trap is defined by the claims that follow.

What is claimed is:

1. A flying pest trap comprising:
a liquid holding cavity defined by a bottom surface and one or more substantially vertical walls;
an island feature positioned within the liquid holding cavity; and
a bait holding mechanism positioned on top of the island feature.

2. The flying pest trap of claim 1, wherein the one or more substantially vertical walls have a larger diameter at the top than at the bottom.

3. The flying pest trap of claim 2, wherein, when stacked on top of a second trap, an interior cavity defined by the island feature accommodates the bait holding mechanism of the second trap.

4. The flying pest trap of claim 2, further comprising a plurality of support ribs positioned along the interior surface of the one or more walls and operable to support the base of a second flying pest trap.

5. The flying pest trap of claim 1, wherein the bait holding mechanism is selected from the group consisting of a spike, a clip, a hook, a barb and a hoop.

6. A flying pest trap comprising:
a liquid holding cavity defined by a bottom surface and one or more substantially vertical walls;
an island feature positioned within the liquid holding cavity; and
one or more bait holding mechanisms anchored on the island feature and extending radially outward over the liquid holding cavity.

7. The flying pest trap of claim 6, further comprising a positioning mechanism that is operable to translate a bait holding mechanism from a first position to a second position, wherein the first position extends the bait holding mechanism radially outward over the liquid holding cavity and the second position places the bait holding mechanism proximate to a side of the island feature.

8. The flying pest trap of claim 7, wherein the positioning mechanism is a spring.

9. The flying pest trap of claim 7, wherein the one or more substantially vertical walls have a larger diameter at the top than at the bottom.

10. The flying pest trap of claim 9, wherein, when stacked on top of a second trap, an interior cavity defined by the island feature accommodates the island feature and bait holding mechanisms of the second trap.

11. The flying pest trap of claim 6, wherein the bait holding mechanisms are selected from the group consisting of a spike, a clip, a hook, a barb and a hoop.

12. A flying pest trap comprising:
a liquid holding cavity defined by a bottom surface and one or more substantially vertical walls; and
one or more bait holding mechanisms anchored on the one or more walls and extending radially inward over the liquid holding cavity.

13. The flying pest trap of claim 12, further comprising a positioning mechanism that is operable to translate a bait holding mechanism from a first position to a second position, wherein the first position extends the bait holding mechanism radially inward over the liquid holding cavity and the second position places the bait holding mechanism proximate to the wall.

14. The flying pest trap of claim 13, wherein the positioning mechanism is a spring.

15. The flying pest trap of claim 13, wherein the one or more substantially vertical walls have a larger diameter at the top than at the bottom.

16. The flying pest trap of claim 12, wherein the bait holding mechanism is selected from the group consisting of a spike, a clip, a hook, a barb and a hoop.
